(19) United States
(12) Patent Application Publication
(10) Pub. No.: US 2007/0139388 A1
(43) Pub. Date: Jun. 21, 2007

(54) Touch pad structure for notebook computer

(76) Inventor: Shao-Ming Lee, Nantou (TW)

Correspondence Address: Rosenberg, Klein & Lee, Suite 101, 3458 Ellicott Center Drive, Ellicott City, MD, 21043, US

(21) Appl. No.: 11/450,307

(22) Filed: Jun. 12, 2006

(30) Foreign Application Priority Data
Dec. 16, 2005 (TW) 94222047

(51) Int. Cl. G09G 5/00

(52) U.S. Cl. 345/173

(57) ABSTRACT

An improvement of a touch pad structure for a notebook computer comprises a housing, a printed circuit board, a plurality of keys and a touch pad. The housing downwardly concaves to form a contained groove, and the printed circuit board is installed in the contained groove and has a plurality of metal switch springs thereon. The keys are disposed on the printed circuit board and are separately correspond to the metal switch springs of the printed circuit board, and the touch pad is installed in the contained groove and the touch pad and the keys have a veneer board thereon. Whereby it is to provide a convenient assembly, artistic effect, better touch of keys, partially waterproof effect and to maintain a structure strength of the housing.

### BACKGROUND OF THE INVENTION

1. Field of the invention

The present invention relates to a notebook computer, and more particularly to an improvement of a touch pad structure for the notebook computer to avoid damaging structure strength of a housing of the notebook computer.

2. Description of the Prior Art

Recently with the rapidly development of notebook computers, many factories of the notebook computers make efforts in light, thin, short, and small products, such as the touch pads.

Reference is made to FIG. 1, which is an exploded perspective view of a touch pad structure of the prior art. The touch pas structure comprises an opening 12 is disposed on a suitable location of a housing 10 of a portable notebook computer. The housing 10 is adjoined to a keyboard 11, a supporting base 14 is disposed in the opening 12. Each of four corners of the supporting base 14 downwardly has a hollow cylinder 15 and the hollow cylinders 15 are covered by elastic elements 16, and each of four cylinders 17 disposed on a bottom casing 19 of the keyboard 11 is inserted into the cylinders 15 respectively. A touch pad cushion 13 is disposed on the supporting base 14 and exposed to the opening 12 for driving the free movement on the supporting base 14. An optical circuit board 18 is disposed between the supporting base 14 and the bottom casing 19.

The opening 12 is opened from the housing 10, the optical circuit board 18, the supporting base 14 and the touch pas cushion 13 are disposed between the bottom casing 19 and the housing 10. However, the hollow opening 12 is opened from the housing 10, it is to reduce the whole structure strength. When the housing 10 is pressured, it is easily to crack around the opening 12 so to frequently replace or repair the housing 10. In addition, when water is splashed on the housing 10, it is easily to directly permeate into the opening 12 to damage or erode internal components.

References are made to FIG. 2 and FIG. 3, which are a perspective view and a side view of another touch pad structure of the prior art. The touch pad structure comprises a touch pad 20, a touch pad base 21 and a plurality of keys 22. The touch pad base 21 is forwardly extended to form a plurality of stands 23 and protruded from a front edge of the touch pad base 21. Each of the stands 23 is corresponded to an electrical button 24 thereunder, and a plurality of the keys 22 are separately embedded on the stands 23. When the keys 22 are pressed, the stands 23 of the touch pad based 21 are forced to curve so as to directly press the electrical buttons 24 down for a switch function.

The touch pad base 21 and the keys 22 have a certain elasticity, however, the keys 22 are pressed to press the electrical buttons 24 for a long time to cause a bad touch so as to harm users' fingers and wrists.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide an improvement of a touch pad structure for a notebook computer that is to have the effect and function of convenient assembly, better touch of keys, strong structure strength, and partially waterproof function.

For achieving the primary objective stated above, the improvement of the touch pad structure for the notebook computer comprises a housing that downwardly concaves to form a contained groove, a printed circuit board is installed in the contained groove and has a plurality of metal switch springs thereon, a plurality of keys are disposed on the printed circuit board and are separately corresponded to the metal switch springs of the printed circuit board, and a touch pad is installed in the contained groove and is disposed on the printed circuit board.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is an exploded perspective view of a touch pad structure of the prior art;

FIG. 2 is a perspective view of another touch pad structure of the prior art;

FIG. 3 is a side view of the FIG. 2;

FIG. 4 is a perspective view of a touch pad structure for a notebook computer of the present invention;

FIG. 5 is an exploded view of the touch pad structure for the notebook computer of the present invention;

FIG. 6 is a cross-sectional view of the touch pad structure for the notebook computer of the present invention;

FIG. 6A is a partial enlarged view of the FIG. 6; and

FIG. 7 is a perspective view of the touch pad structure is installed on the notebook computer of the present invention.

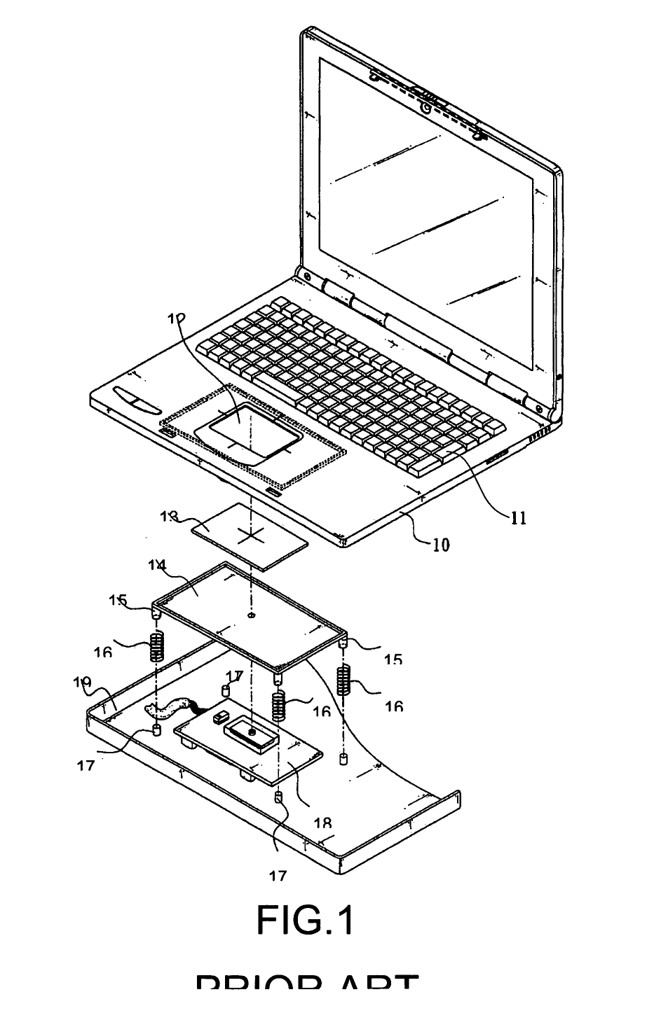

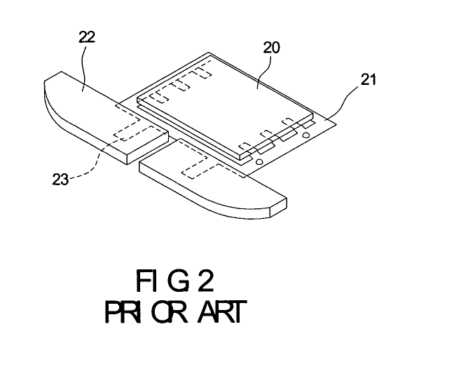

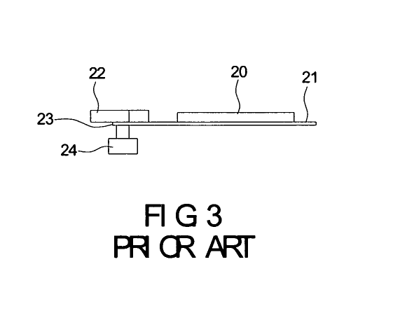

The drawings will be described further in connection with the following detailed description of the present invention.

### DETAILED DESCRIPTION OF THE PREFERRED EMBODIMENTS

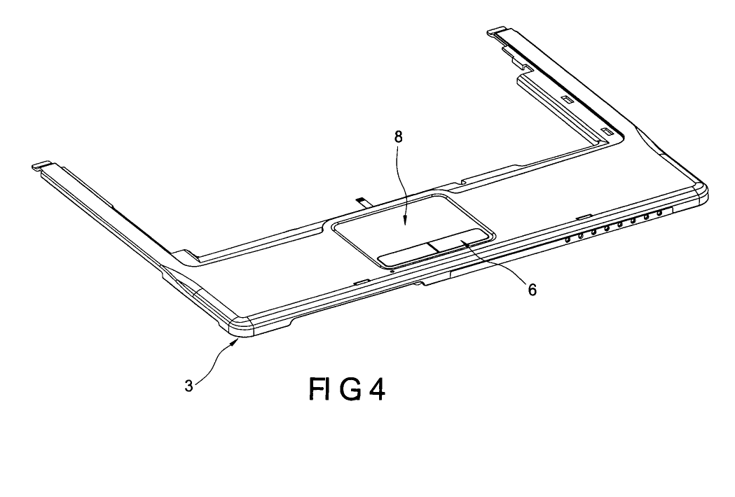

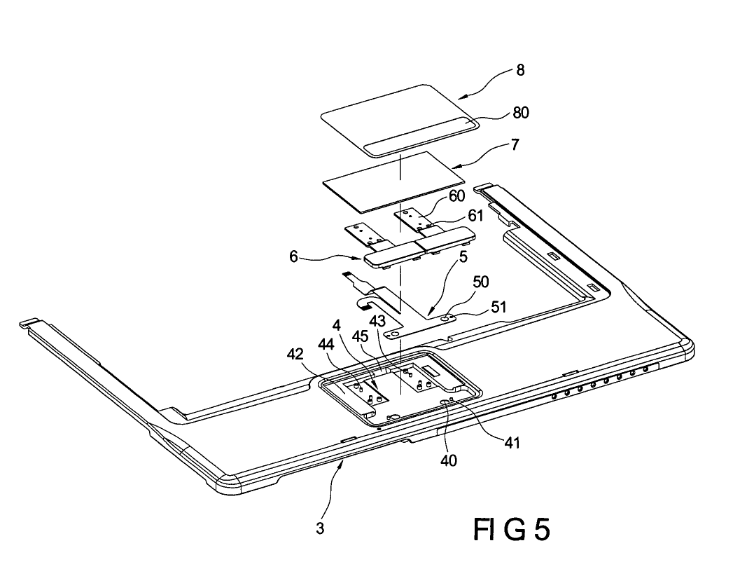

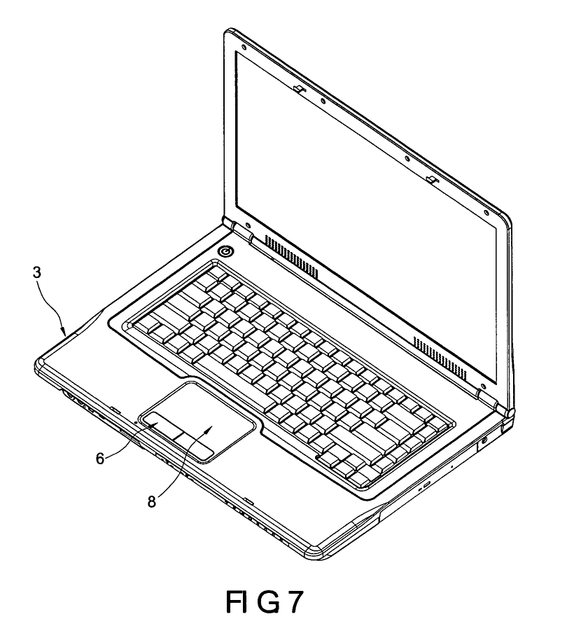

References are made from FIG. 4 to FIG. 7. The present invention provides an improvement of a touch pad structure for a notebook computer that comprises a housing 3, a contained groove 4, a printed circuit board 5, a plurality of keys 6, a touch pad 7 and a veneer board 8, and the housing 3 downwardly concaves to form the contained groove 4.

The contained groove 4 has a plurality of sunken holes 40, a plurality of first positioning pillars 41, two leaning portions 42, a plurality of second positioning pillars 43 and a plurality of third positioning pillars 44. The sunken holes 40 are separately disposed in two front sides of the contained groove 4 and downwardly extended to a distance. The first positioning pillars 41 are separately adjoined to one side of the sunken holes 40, the leaning portions 42 are separately protruded and disposed on two sides of the contained groove 4, the second positioning pillars 43 and the third positioning pillars 44 are separately disposed on two sides of the contained groove 4 and separately corresponded to the sunken holes 40 and the first positioning pillars 41. The contained groove 4 has an open hole 45 in a rear side edge of the contained groove 4 and the open hole 45 is penetrated through the housing 3.

The printed circuit board 5 is a flexible printed circuit board, and has a plurality of dome-shaped metal switch springs 50, a plurality of through holes 51 are disposed thereon. The through holes 51 are separately adjoined to one side of the metal switch springs 50, and a bottom surface of the printed circuit board 5 has a backing layer (not shown) for attaching the printed circuit board 5 on the surface of the contained groove 4.

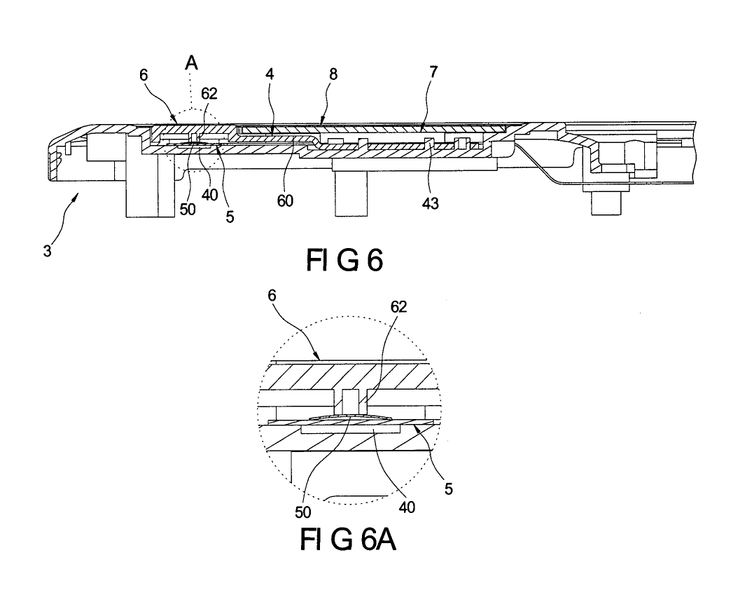

Each one end of the keys 6 is extended to form a fixed portion 60, the fixed portions 60 have a plurality of positioning holes 61 and a bottom surface of the keys 6 is downwardly extended to form protruding ends 62, and the bottom surface of the keys 6 are hollow-shaped (shown in FIG. 6 and FIG. 6A).

The touch pad 7 is rectangle-shaped and is electrically connected with the printed circuit board 5, and the touch pad 7 is used to control the direction of the cursor by touching and moving the fingers on the touch pad 7. Furthermore, the touch pad has a backing layer (not shown) on a bottom surface thereof.

The veneer board 8 is rectangle-shaped and has an open groove 80 in front of the veneer board 8 and a bottom surface of the veneer board 8 has a backing layer (not shown), and the veneer board 8 has color layer for providing an artistic effect.

The printed circuit board 5 is disposed in the contained groove 4, and a rear end of the printed circuit board 5 is penetrated through the open holes 45 of the contained groove 4 for electrically connecting with a motherboard (not shown). The through holes 51 are separately fixed on the first positioning pillars 41 so that the metal switch springs 50 are separately corresponded to the sunken holes 40. The keys 6 are disposed on the printed circuit board 5 and separately corresponded to the metal switch springs 50 of the printed circuit board 5. The positioning holes 61 of the fixed portions 60 are separately fixed on the second positioning pillars 43 and the third positioning pillars 44 so that the protruding ends 62 of the keys 6 are separately corresponded to the metal switch springs 50 of the printed circuit board 5. When the keys 6 are pressed, the protruding ends 62 of the keys 6 are touched to the metal switch springs 50 of the printed circuit board 5 to obtain a switch action. The touch pad 7 is attached on the leaning portions 42 of the contained groove 4 and by using the backing layer. The veneer board 8 is disposed on the touch pad 7 and the keys 6, the keys 6 are corresponded to the open groove 80, and the veneer board 8 can be attached around the contained groove 4 and on the touch pad 7 by using the backing layer.

Thereby, the present invention to provide an improvement of a touch pad structure that is to prevent the defective function of the keys 6, and the veneer board 8 has color layer corresponding with the notebook computer for providing an artistic effect. Secondly, the efficacy of metal switch springs 50 and the sunken holes 40 provides a better touch of keys 6 to prevent harming users' fingers and wrists during a long time of using the notebook computer. Finally, the housing 3 downwardly concaves to form the contained groove 4 provides the strength structure of the housing 3, and a partially waterproof function for providing water permeating into the inner structure of the notebook computer to damage or erode internal components.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An improvement of a touch pad structure for a notebook computer, comprising:
a housing downwardly concaving to form a contained groove;
a printed circuit board installed in the contained groove, and having a plurality of metal switch springs thereon;
a plurality of keys disposed on the printed circuit board and separately corresponded to the metal switch springs of the printed circuit board; and
a touch pad installed in the contained groove and disposed on the printed circuit board.

2. The improvement of the touch pad structure for the notebook computer as in claim 1, wherein the contained groove has a plurality of sunken holes therein, and the metal switch springs are corresponded to the sunken holes.

3. The improvement of the touch pad structure for the notebook computer as in claim 1, wherein the contained groove has a plurality of first positioning pillars therein, and the printed circuit board has a plurality of through holes are firmly connected with the first positioning pillars separately.

4. The improvement of the touch pad structure for the notebook computer as in claim 1, wherein the contained groove has a plurality of second positioning pillars and third positioning pillars; each one end of the keys forms a fixed portion, a plurality of positioning holes are formed on the fixed portions, and the positioning holes are firmly connected with the second positioning pillars and the third positioning pillars separately so that the keys are corresponded to the metal switch springs.

5. The improvement of the touch pad structure for the notebook computer as in claim 1, wherein the contained groove has two leaning portions are protrudently disposed on two sides of the contained groove, and the touch pad is disposed on the leaning portions.

6. The improvement of the touch pad structure for the notebook computer as in claim 1, wherein the contained groove has an open hole in a rear side edge thereof, the open hole is penetrated through the housing, and a rear end of the printed circuit board is penetrated through the open hole of the contained groove and is electrically connected with a motherboard.

7. The improvement of the touch pad structure for the notebook computer as in claim 1, wherein the printed circuit board is a flexible printed circuit board, and the metal switch springs are dome-shaped.

8. The improvement of the touch pad structure for the notebook computer as in claim 1, wherein a bottom surface of the keys is downwardly extended to form a protruding terminal, and the bottom surface of the keys is hollow-shaped.

9. The improvement of the touch pad structure for the notebook computer as in claim 1, wherein the touch pad is electrically connected with the printed circuit board.

10. The improvement of the touch pad structure for the notebook computer as in claim 1, wherein the touch pad and the keys have a veneer board thereon.

11. The improvement of the touch pad structure for the notebook computer as in claim 10, wherein the veneer board has an open groove, and the keys are corresponded to the open groove.
